(19) United States
(12) Patent Application Publication
(10) Pub. No.: US 2011/0314678 A1
(43) Pub. Date: Dec. 29, 2011

(54) BENT RAZOR BLADES AND MANUFACTURING THEREOF

(76) Inventor: Mark Peterson, Reading (GB)

(21) Appl. No.: 12/825,889

(22) Filed: Jun. 29, 2010

(51) Int. Cl. B26B 21/14; B21K 11/00

(52) U.S. Cl. 30/77; 76/104.1; 30/84

(57) ABSTRACT

A razor blade manufactured by the process of cutting a strip of blade steel into discrete blanks each having an elongated edge and an elongated support portion extending between a pair of lateral end faces generally transverse to the elongated edge. The elongated edges are sharpened to form a cutting edge. The discrete blanks are deformed to form a bent portion. The lateral end faces are treated to remove cracks prior to being deformed.

### FIELD OF THE INVENTION

The present invention relates to razor cartridges and blades in general and, more particularly, to razor blade cartridges having one or more razor blades with a bent portion and a method for manufacturing the same.

### BACKGROUND OF THE INVENTION

Razor blades are typically formed of a suitable metallic sheet material such as stainless steel, which is slit to a desired width and heat-treated to harden the metal. The hardening operation utilizes a high temperature furnace, where the metal may be exposed to temperatures greater than 1145° C., followed by quenching. After hardening, a cutting edge is formed on an elongated edge of the blade. The cutting edge typically has a wedge-shaped configuration with an ultimate tip having a radius less than about 1000 angstroms, e.g., about 200-300 angstroms.

The razor blades are generally mounted on a plastic housing (e.g., a cartridge for a shaving razor) or on a bent metal support that is attached to a housing. The razor blade assembly may include a planar blade attached (e.g., welded) to a bent metal support. The blade may include a tapered region that terminates in a sharpened cutting edge. This type of assembly is secured to shaving razors (e.g., to cartridges for shaving razors) to enable users to cut hair (e.g., facial hair) with the cutting edge. The bent metal support may provide the relatively delicate blade with sufficient support to withstand forces applied to blade during the shaving process. Examples of razor cartridges having supported blades are shown in U.S. Pat. No. 4,378,634 and in U.S. patent application Ser. No. 10/798,525, filed Mar. 11, 2004, which are incorporated by reference herein.

The performance and commercial success of a razor cartridge is a balance of many factors and characteristics that include rinsability (i.e., the ability of the user to be able to easily rinse cut hair and skin particles and other shaving debris from the razor cartridge and especially from between adjacent razor blades or razor blade structures). The distance between consecutive cutting edges or so-called “span” is theorized to affect the shaving process in several ways. The span between cutting edges may control the degree to which skin will bulge between blades, with smaller spans resulting in less skin bulge and more skin comfort during shaving, but may also increase opportunities for double engagement. Larger spans may reduce opportunities for double engagements, but may result in more skin bulge between cutting edges and less skin comfort. The span between cutting edges and, thus between blades, may affect rinsing of shave preparations and shave debris after a shaving stroke, with larger spans easing or quickening rinsing and smaller spans slowing or making rinsing more difficult. A razor cartridge including a razor blade having a bent portion can have certain advantages, such as decreased manufacturing costs and improved rinsability.

The manufacture of commercially acceptable razor cartridges having one or more bent blades present issues such as failure of the blade during manufacturing or even during shaving. Various bent blade designs have been suggested in the literature; however, these designs often result in failure in certain types of steel (e.g., the blades crack or fracture during bending). Accordingly, the geometry of the blade is usually compromised to prevent failure (e.g., bent portion has a larger radius). In multi-bladed systems bent blades having a larger radius result in decreased rinsability. Alternatively, a softer steel may be used to achieve the desired bend radius; however, this also has drawbacks. Blades manufactured from softer steels often do not have the necessary edge strength for a close and comfortable shave.

### SUMMARY OF THE INVENTION

In one aspect, the invention features, in general, a process for manufacturing a razor blade in which a strip of blade steel is cut into discrete blanks each having an elongated edge and an elongated support portion extending between a pair of lateral end faces that are generally transverse to the elongated edge. The elongated edges are sharpened to form a cutting edge. The discrete blanks are deformed to form a bent portion. The pair of lateral end faces of the discrete blacks is treated to remove cracks. The manufacturing process may optionally include grinding the lateral end faces to an average roughness of about 0.45 um to about 1.0 um at a distance of about 1.0 mm to about 2.5 mm from elongated edge.

In another aspect, the invention features, in general, a razor cartridge having a housing with a guard and a cap. A bent blade is mounted to the housing between the guard and the cap. The bent blade has a cutting edge extending parallel to the cap and the guard, an elongated support portion, a bent portion between the cutting edge and the base portion, and a pair of lateral end faces generally transverse to the cutting edge. The lateral end faces have an average roughness of about 0.45 to about 1.0 um.

### BRIEF DESCRIPTION OF THE DRAWINGS

FIG. 1 is a perspective view of an embodiment of a shaving razor of the present disclosure.

FIG. 2A is a perspective view of an embodiment of a blade which may be incorporated into the shaving razor of FIG. 1.

FIG. 2B is side view of the blade of FIG. 2.

FIG. 3 is a partial top view of a bent blade having a macro-crack.

FIG. 4 is a partial top view of a bent blade without a macro-crack

FIG. 5 is a schematic view of an embodiment for a process of manufacturing the blades of FIG. 2A.

FIGS. 6A and 6B are schematic views of a method of forming a bent portion in a strip of blade steel.

### DETAILED DESCRIPTION OF THE INVENTION

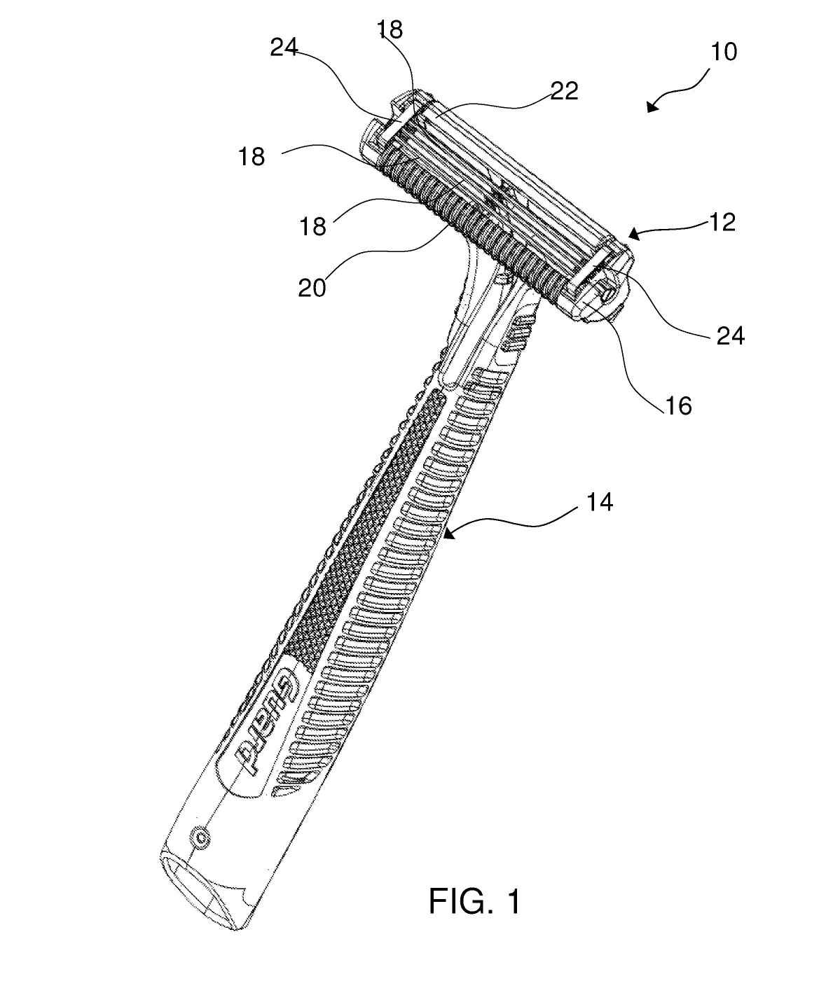

Referring to FIG. 1, one embodiment of the present disclosure is shown illustrating a shaving razor 10 having a shaving cartridge 12 mounted to a shaving razor handle 14. The shaving cartridge 12 may be pivotably (i.e., rotation of the cartridge 12 about an axis relative to the shaving razor handle 14) and/or detachably engaged to the shaving razor handle 14. The shaving cartridge 12 may include a housing 16 dimensioned to receive at least one bent blade 18. Although three blades 18 are shown, the housing 16 may have more or fewer blades 18 depending on the desired performance and cost of the shaving razor 10. The housing 16 may have a guard 20 in front of the blades 18 and a cap 22 behind the blades 18. The guard 20 and the cap 22 may aid in establishing a proper shaving geometry (e.g., blade exposure) for the shaving cartridge 12.

The blades 18 may be mounted to the housing 16 and secured in at least one direction by at least one clip 24. The blades 18 may be rigidly fixed to the housing such that the blades 18 do not move relative to the housing 16 during a shaving stroke. Alternatively, the blades 18 may be spring loaded within the housing 16 such that the blades 18 are pushed up against the clips 24 in a neutral or rest position. The blades 18 may move slightly away from the clips 24 during a shaving stroke. As shown in FIG. 1, two clips 24 may be bent over the blades 18 and around at least a portion of the housing 16 to secure the blades 18 within the housing 16. Although the clips 24 are shown as two separate components fixing the blades 18 within the housing 16, the clips 24 may also be a single piece design. In addition, the clips 24 may not necessarily be bent or formed around a portion of the housing to fix the blades 18 relative to the housing 16. For example, the clips 24 may be snapped fit, press fit, glued, or ultrasonically welded to the housing 16 in order rigidly fix the clips 24 to the housing 16. The clips 24 may comprise a metal (e.g., aluminum or stainless steel) or a polymeric material (e.g., Noryl™ (a blend of polyphenylene oxide (PPO) and polystyrene developed by General Electric Plastics, now SABIC Innovative Plastics), acrylonitrile butadiene styrene (ABS), acetal, polypropylene, high impact polystyrene, or any combinations thereof. Other assembly methods known to those skilled in the art may also be used to secure the blades 18 to the housing 16 including, but not limited to, wire wrapping, cold forming, hot staking, insert molding, and adhesives.

The housing 16 and the handle 14 may be injection molded from a semi-rigid polymeric material. In certain embodiments, the housing 16 and/or the handle 14 may be molded from Noryl™ (a blend of polyphenylene oxide (PPO) and polystyrene developed by General Electric Plastics, now SABIC Innovative Plastics). The housing 16 and/or the handle 14 may be molded from other semi-rigid polymers having a Shore A hardness of about 60 to 140, including, but not limited to acrylonitrile butadiene styrene (ABS), acetal, polypropylene, high impact polystyrene, or any combinations thereof. The guard 20 may be molded from the same material as the housing 16 or a softer material. For example, the guard 20 may be molded from materials having a shore A hardness of about 20 to about 70, such as thermoplastic elastomers (TPEs) or rubbers. The cap 22 may also be molded from the same material as the housing 16. In certain embodiments, the cap 22 may have an elongated strip containing a shaving aid to provide lubrication to the surface of the skin during shaving.

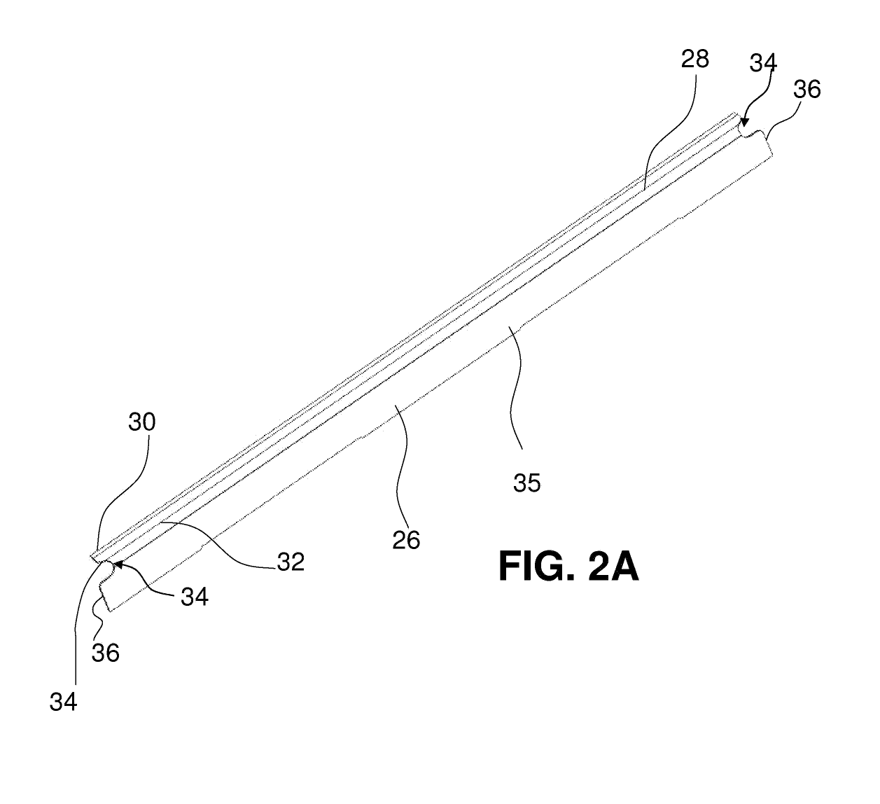

Referring to FIGS. 2A and 2B, a perspective view and a side view of one of the blades 18 are shown, respectively. The blades 18 may integrally formed from a single piece of material that is bent and sharpened (either prior to bending or after bending). In most instances, the material is selected from the group of materials consisting of stainless steel, aluminum, ceramic, glass, plastic, and combinations thereof. The material may be bent using any suitable means known for the particular material being bent. The blades 18 may have an elongated support portion 26 along one lengthwise side, a tapered portion 28, along an opposing lengthwise side, narrowing to a sharpened cutting edge 30, and a bent portion 32 disposed between the elongated support portion 26 and the tapered portion 28. The manufacturing process may result in a notch 34 located on opposing ends of the bent blade 18 between the support portion and the tapered portion 28. The notches 34 may facilitate the handling of the blades 18 during the assembly process. It is understood that the notches 34 are optional and not required. The elongated support portion 26 may have a thickness of about 0.075 mm, 0.085 mm, or 0.095 mm to about 0.105 mm, 0.115 mm, or 0.127 mm. The thickness of the bent portion 32 and the tapered portion 28 may be the same or similar to the elongated support portion 26. Relative to the elongated support portion 26, the tapered portion 28 may extend at an angle of about 90 degrees, 95 degrees, or 100 degrees to about 105 degrees, 110 degrees or 115 degrees. It is understood that depending on the orientation of the bent blade 18 within the housing 16 (FIG. 1), the angle of the elongated support portion 26 relative to the tapered portion 28 may be less than 90 degrees (e.g., about 5 degrees to about 25 degrees). For example, in certain embodiments, the elongated support portion 26 may be oriented generally parallel to a line tangent to the guard 20 and the cap 22. The cutting edge 30 of the tapered portion 28 may have a wedge-shaped configuration with an ultimate tip having a radius less than about 1000 angstroms (e.g., about 100 angstroms, 200 angstroms, or 300 angstroms to about 500 angstroms, 700 angstroms, or 950 angstroms). An advantage of the disclosed bent razor blades 18 having a bent portion 32 is that it can be used in a razor cartridge as an alternative to a planar razor blade mounted on a thicker bent support. The bent blades 18 may facilitate improved rinsing of the cartridge 12 (FIG. 1).

In certain embodiments, the bent blade 18 (e.g., the elongated support portion 26) may have a hardness of about 540 HV to about 750 HV (e.g., about 540 HV to about 620 HV). In some embodiments, the bent portion 32 may have a hardness that is less than the hardness of the elongated support portion 26. The bent portion 32 may, for example, have a hardness of about 540 HV to about 620 HV. The hardness of the bent blade 18 may be measured by ASTM E92-82—Standard Test Method for Vickers Hardness of Metallic Materials. In certain embodiments, the bent blade 18 may have a substantially uniform hardness. In other embodiments, the cutting edge 30 may harder than the other portions of the bent blade 18. The cutting edge 30 may have a hardness of about 550 HV, 600 HV, or 650 HV to about 700 HV, 725 HV, or 750 HV.

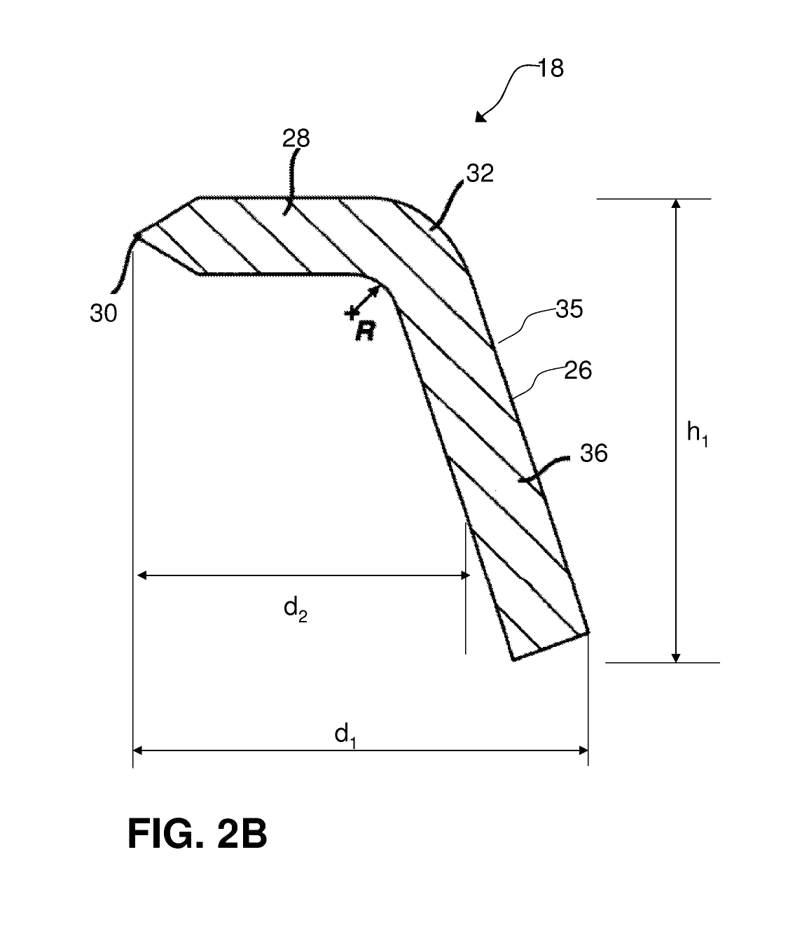

Referring to FIG. 3, a side view of the bent blade 18 is shown. The thickness of the support portion 26 may provide for a sufficient inner bend radius R. In certain embodiments, the value for R may be about 0.30 mm, 0.40 mm, or 0.50 mm to about 0.60 mm, 0.70 mm, or 0.80 mm The elongated support portion 26 may have a rear face 35 opposite the side of the inner bend radius. The elongated support portion 26 may have a height h₁ of about 1.0 mm, 1.5 mm, or 2.0 mm to about 2.2 mm, 2.5 mm, or 2.7 mm. The bend radius allows the bent blade 18 to have a reduced foot print to improve the spacing of the bent blades 18 within the cartridge 14 (FIG. 1). For example, distance “d₁” between the rear face 35 and the cutting edge 30 may be about 0.85 mm, 0.90 mm, or 0.95 mm to about 1.0 mm, 1.10 mm, or 1.2 mm. As the value d₁ decreases, the available space between adjacent blades in a cartridge for rinsing increases.

In some embodiments, the tapered portion 28 and/or the elongated support portion 26 have minimal levels of bow and sweep. Bow is a term used to describe an arching normal to the plane in which the portion of the cutting member is intended to lie. Sweep, also commonly referred to as camber, is a term used to describe an arching within the plane in which the portion of the cutting member lies (e.g., an arching of the longitudinal edges of the portion of the cutting member). In some embodiments, the tapered portion 28 has a bow of about +0.0004 to about −0.002 inch (+0.01 to −0.05 millimeter) or less across the length of the blade portion. In certain embodiments, the tapered portion 28 has a sweep of about ±0.0027 inch (±0.07 millimeter) or less across the length of the tapered portion 28. The elongated support portion 26 can have a bow of about ±0.0024 inch (±0.060 millimeter) or less across the length of the base portion. By reducing the levels of bow and/or sweep in the tapered portion 28 and/or the elongated support portion 26, the comfort of the user and/or the cutting performance of bent blade 18 can be improved.

The blades 18 must have a sufficient bend radius R to achieve the desired shaving geometry (e.g., interblade span, which is the distance between adjacent cutting edges 30 within the cartridge 12) for rinsing and overall shaving performance. Generally, softer materials may be bent to a sufficient bend radius; however these materials are difficult to sharpen such that the cutting edge 30 has sufficient strength and sharpness for close and comfortable shave. Generally, stiffer materials may be sharpened such that the cutting edge 30 has sufficient strength and sharpness; however the blades 18 often break during bending because the blade material is more brittle. Accordingly, the bend radius must often be decreased to avoid failure of the bent blade 18 which may compromise shaving performance.

Every part's surface (e.g., the lateral end faces 36 of the bent blade 18) is made up of texture and roughness which varies due to manufacturing techniques and the part structure itself. The average roughness (Ra value) of blade may be measured using a white-light 3D surface profiler (e.g., ZYGO, NV5000 Corporation, Middlefield, Conn.). The average roughness Ra is the computed average of all deviations of the roughness profile from the median line over the defined length. The white-light 3D surface profiler (WLS) provides fast, non-destructive, quantitative surface characterization of step heights, texture, roughness, and other surface topography parameters. This measurement technique is non-contact, three-dimensional, scanning white light and optical phase-shifting interferometry. Scanning white-light interferometry is a traditional technique that uses fringe contrast to yield surface information. A pattern of bright and dark lines (fringes) result from an optical path difference between a reference and a sample beam. Incoming light is split inside an interferometer, one beam going to an internal reference surface and the other to the sample. After reflection, the beams recombine inside the interferometer, undergoing constructive and destructive interference and producing the light and dark fringe pattern. WLS combines the power of modern high-speed computers with the vast amount of surface information produced by white-light interferometry. This permits WLS-based systems to measure surface features far more accurately than those measurable with conventional phase-measuring interferometry techniques. The most accurate of these systems, when operated in ideal environment have a repeatable accuracy of 0.0000025 inches or 0.0635 microns.

As shown in FIGS. 2A and 2B, the bent blade 18 may have a pair of lateral end faces 36 transverse to the elongated support portion 26 (opposite face not shown in FIG. 2B), which may be the result of a strip of blade steel being segmented. The segmenting process may result in the lateral end faces 36 having a very rough surface. The lateral end faces of shaving razor blades do not contact the skin and are typically hidden away within the cartridge. The average roughness may be measured a distance “d₂” from the cutting edge 30. The distance d₂ may represent the approximate location of the bent portion 32 from the cutting edge 30 and this area is subjected to high levels of stress during manufacturing to achieve the desired inner bend radius. In certain embodiments, the distance d₂ may extend only a small distance from the cutting edge 30 or the entire length of the lateral end faces 36 (e.g., along d₁). For example the distance d₂ may be about 0.5 mm, 1.0 mm, or 1.5 mm to about 1.75 mm, 2.5 mm, or 3.0 mm. The lateral end faces 36 of a typical production razor blade have an average roughness (Ra) of about 2.10 um to about 3.30 um measured about 1.0 mm to about 2.5 mm from the cutting edge 30. The average roughness (Ra) of the lateral end faces 36 can vary significantly from the cutting edge 30 to the elongated support portion 26. Accordingly, during the bending process some blades may fail and some blades may not for no apparent reason. The lateral end faces 36 may have a high average roughness (Ra) because of the presence of micro-cracks (and even macro-cracks) along the lateral end faces 36 caused by the segmenting of a strip of blade steel into smaller blades (or other manufacturing processes). The lateral end faces 36 may be treated to remove the micro-cracks and/or macro-cracks. The treating of the lateral end faces 36 may include various mechanical, thermal and chemical processes, including, but not limited to grinding, laser and welding processes, and electro-polishing to remove or fill in cracks (micro and/or macro-cracks). For example, the average roughness (Ra) of the lateral end faces 36 after a typical grinding process may be about 0.40 um, 0.45 um, or 0.50 um to about 0.60 um, 0.75 um, or 1.0 um along d₂. The term “about” in regards to the average roughness (Ra) is defined as within the limits of the resolution (vertical and lateral) of the equipment used to measure the average roughness (Ra) of the lateral end faces 36 of the bent blade 18.

FIG. 3 illustrates a representative example of cracking of the bent blade 18 in an area of the bent portion 32 and more especially on the outer surface 29 of the bent portion 32. While cracks of a micro scale located in the outer surface 29 of the bent portion 32 may be acceptable, cracks of a macro scale may result in breakage of the bent blade 18 during normal use or when mounted in its cartridge housing. For purposes of the present disclosure a macro-crack is defined as a crack having a depth greater than ⅔ the thickness of the strip of blade steel (e.g., the thickness of the bent portion 32 of the bent blade 18). Cracks also can provide initiation sues for accelerated corrosion that can also result in failure of the razor blade. Failure or fracture of a razor blade can result in nicks and cuts for the user. Without being held to theory, it is believed the lateral end faces 36 of the bent blade 18 have imperfections, such as cracks (macro and micro), that propagate during the bending of the blade resulting in an elongated macro-crack 200 along the bent portion 32. These imperfections are common of blade manufacturing processes and the lateral end faces 36 are not treated because they are not involved in the cutting of hair and/or they are hidden from view within the cartridge. The macro-crack 200 may propagate parallel to and along the bent portion 32 causing complete failure of the bent blade 18. The imperfections and cracks may be evidenced by the high average roughness (Ra) of the lateral end faces 36 of the bent blade 18. For example, an average roughness (Ra) of the lateral end faces for typical production blades have been observed to be about 2.17 um to about 3.30 um measured about 1.0 mm to about 2.5 mm from the cutting edge 30. The bent portion 32 is typically about 1.0 mm to about 2.5 mm from the cutting edge 30; however it is understood this distance may vary.

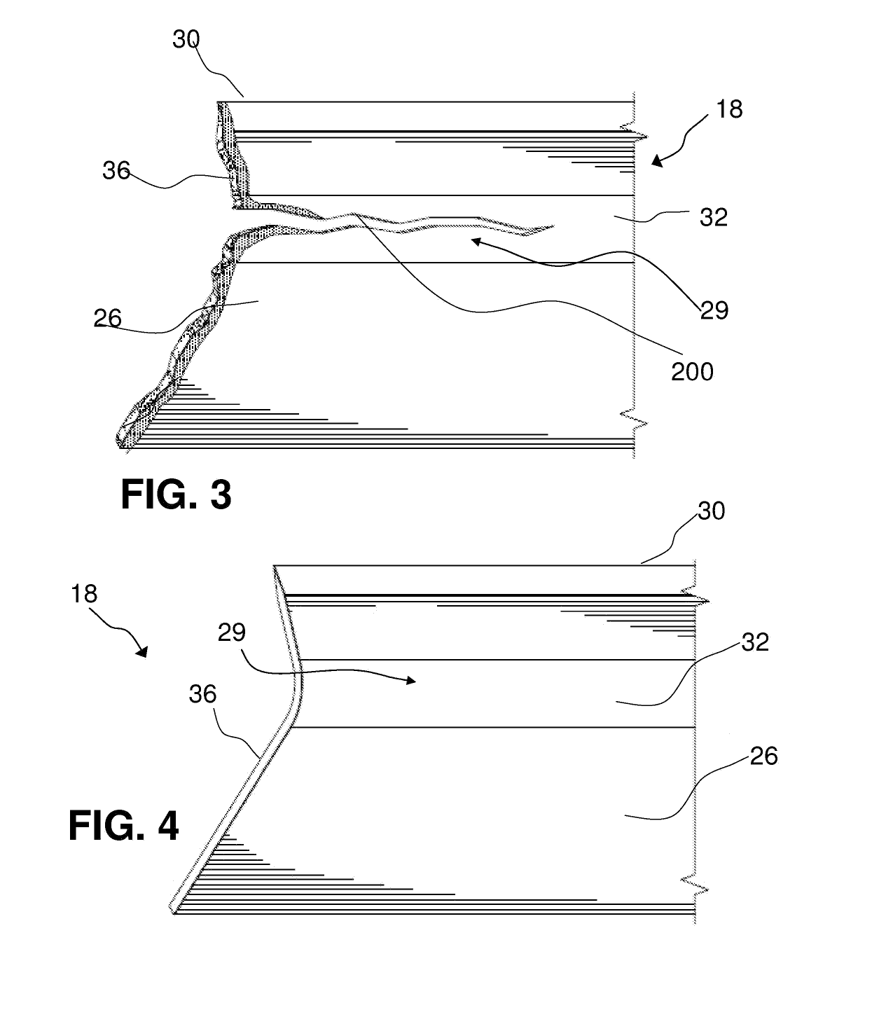

FIG. 4 illustrates a representative example of the bent blade 18 with no macro-cracks of the bent portion 32 and more especially on the outer surface 29 of the bent portion 32. The lateral end faces 36 of the bent blade 18 of FIG. 4 appear to be much smoother and have few if any noticeable cracks or imperfections, as compared to the bent blade 18 of FIG. 3. The lateral end faces 36 of the bent blade 18 of FIG. 4 were ground prior to bending to remove cracks and imperfections. The average roughness (Ra) of the lateral end faces 36 of bent blade 18 of FIG. 4 prior to grinding were similar to the average roughness (Ra) of the lateral end faces 36 of bent blade 18 of FIG. 3 (e.g., about 2.17 um to about 3.30 um measured about 1.0 mm to about 2.5 mm from the cutting edge 30). After grinding the lateral end faces 36 of the bent blade 18 had average roughness (Ra) of about 0.45 to about 0.68 (e.g., along d₂). Not only does the average roughness (Ra) significantly decrease after grinding (or other treatment processes mentioned above), but the standard deviation and range for the average roughness (Ra) along the length lateral end face 36 are also much lower. Accordingly, the lateral end faces 36 after grinding (or other treatment processes mentioned above) have a much lower and more consistent average roughness (Ra), resulting in less macro cracks along the outer surface 29 of the bent portion 32. The decrease of the average roughness (Ra) of the lateral end faces 36 may allow for radius (see FIG. 2B) of the bent portion 32 to be increased without failure of the bent blade 18 (or using a softer blade steel). It is understood that the lateral end faces 36 may be treated to decrease the average roughness (Ra) either before or after sharpening of the cutting edge 30.

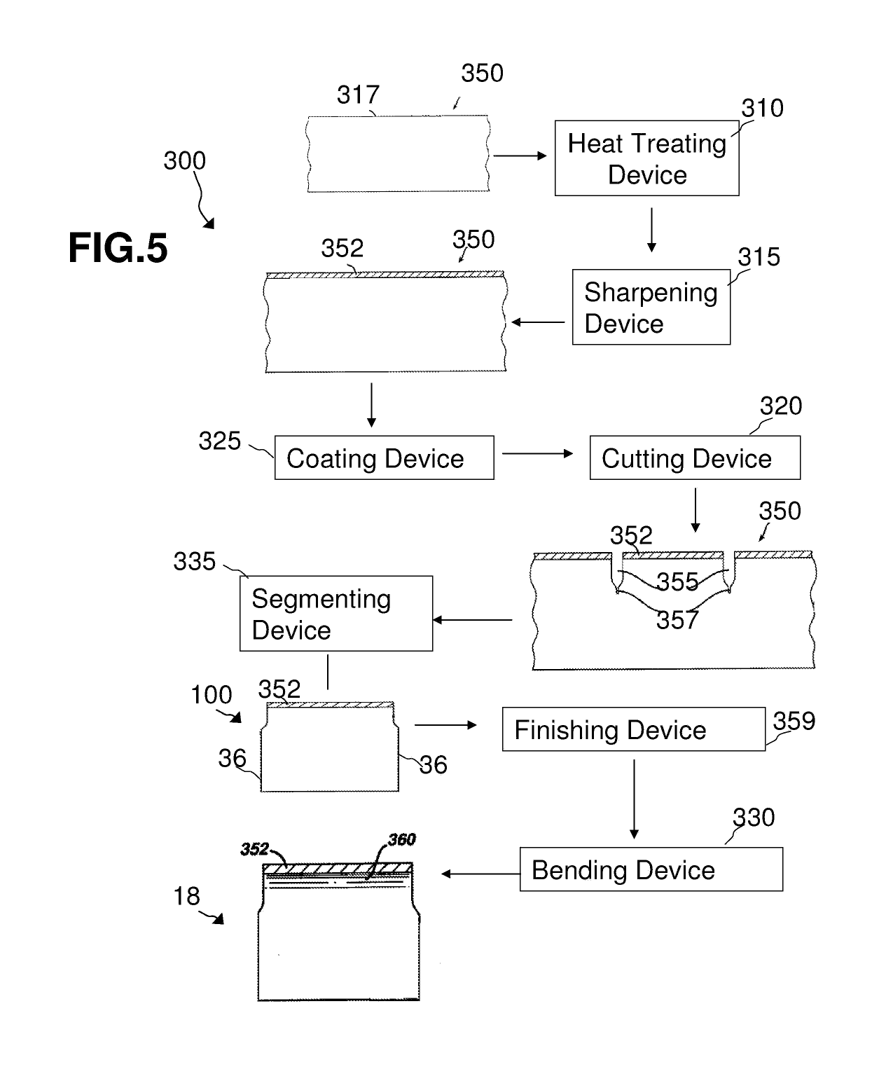

Referring to FIG. 5, an exemplary process 300 for the manufacture of the bent blades 18 is schematically illustrated. The bent blades 18 may be manufactured from a continuous strip of blade steel 350 (e.g., stainless steel). Suitable stainless steel materials may include GIN6, GIN7, and GINB steels (manufactured by HITACHI METALS, Japan), as well as other blade steels. In certain embodiments, the bent blade 18 may formed of a material having a composition comprised of about 0.45 to about 0.55 percent carbon, about 1.20 to about 1.40 percent molybdenum, about 0.70 to about 0.90 percent manganese, about 13 to about 14 percent chromium, no more than about 0.025 percent phosphorus, about 0.45 to about 0.55 percent silicon, and no more than about 0.020 percent sulfur. The bent blade 18 can, for example, be formed of a stainless steel having a carbon content of about 0.4 percent by weight, a chromium content of about 13 percent by weight, a molybdenum content of about 1.25 percent by weight, and amounts of manganese, chromium, phosphorus, silicon and sulfur within the above ranges.

The continuous strip of blade steel 350 may be conveyed (e.g., pulled by a rotating roll from a roll of blade steel to a heat-treating device 310 (which may comprise multiple heat-treating devices), where strip 350 is heat-treated with a heat treating device (e.g., a furnace or oven) to increase the hardness and/or increase the ductility of discrete regions of the blade strip. Strip 350 is then re-coiled into a roll of hardened blade steel, and subsequently unwound and conveyed to a sharpening device 315, where an elongated edge region 317 (e.g., tapered portion 28 of FIG. 2A) of the strip 350 is sharpened to form a cutting edge 352 (e.g., cutting edge 30 of FIG. 2A). The strip 350 is again re-coiled into a roll of heat treated and sharpened blade steel, after which it is coated with hard and lubricious coatings using a coating device 325. The strip 350 is then unwound and conveyed to a cutting/stamping station which includes a cutting device 320. The cutting device 320 may create transverse slots 355 and adjoining slits 357 across longitudinally spaced apart regions of the strip 350.

The strip 350 may then be conveyed to a segmenting device 335. The segmenting device 335 can be any device capable of separating the regions of the strip 350 between the slots 355 from the remainder of the strip 350 to form a plurality of discrete blanks 100. In some embodiments, the separating device 335 may be a punch press. The progression of the strip 350 can be periodically paused to allow the punch press to accurately separate the regions of the strip 350 between the slots 355 from the remainder of the strip 350 to form the discrete blanks 100. The cutting and/or segmenting process often produce discrete blanks 100 having a pair of rough lateral end faces 36. The rough lateral end faces may have micro-cracks and/or macro-cracks that can propagate during subsequent processing steps, such as bending. The lateral end faces of blades are typically not treated because they do not form part of the cutting edge and treating the lateral end faces would be an unnecessary and costly step. Furthermore, the lateral end faces of the blades are typically hidden away within the blade cartridge and not seen by the consumer. Prior to a bending process, the blade segments may go through a finishing device 359 to remove cracks (micro-cracks and/or macro-cracks) from the pair of lateral end faces 36. Examples of finishing processes may include, but are not limited to, grinding and electro-polishing. The finishing device 359 may produce discrete blanks 100 having a pair of lateral end faces 36 with a surface finish of about 0.45 um to about 1.0 um.

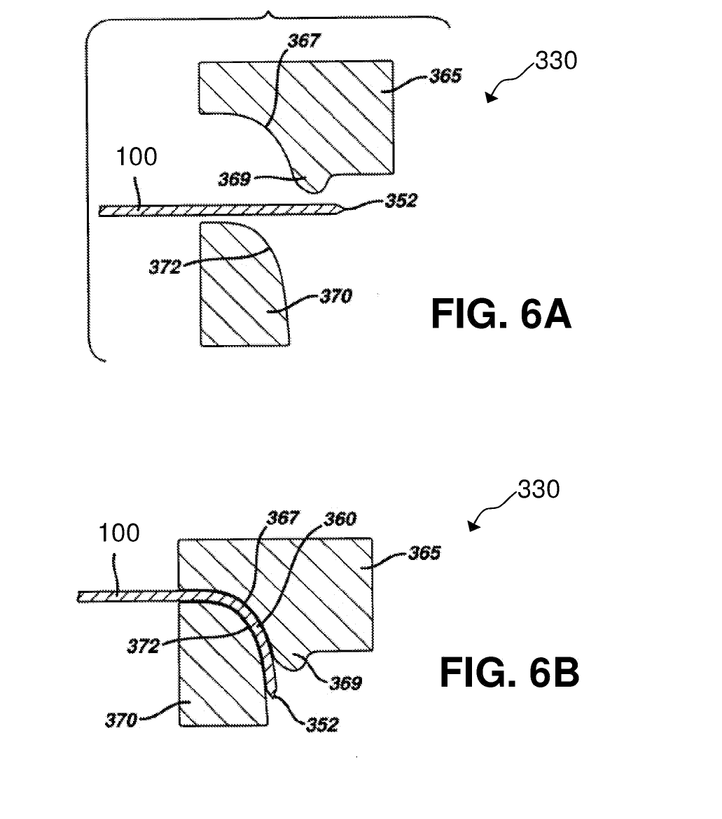

After the finishing step, the discrete blanks 100 may be then conveyed to a bending device 330 that creates a longitudinal bend 360 (e.g., bent portion 32 of FIG. 2A) generally parallel to the sharpened edge 352 (e.g., cutting edge 30 of FIG. 2A) resulting in the bent blade 18. The bending device 330 can be any device capable of forming a longitudinal bend in the discrete blanks 100. In some embodiments, as shown in FIGS. 6A and 6B, the bending device 330 may be an assembly that includes a punch 365 and a die 370. The punch 365 includes a curved portion 367 that is configured to mate with an associated curved portion 372 of the die 370. Generally, curved portion 367 of punch 365 has a radius that is slightly larger than a radius of the curved portion 372 of the die 370. The curved portion 367 of punch 365, for example can have a radius of about 0.0231″ to about 0.0241″, while curved portion 372 of the die 370 can have a radius of about 0.010″ to about 0.014″. The punch 365 also may include a protrusion 369 that is configured to contact a portion of strip 350 that is offset from sharpened edge 352 of the discrete blanks 100.

To form bent region 360 of strip 350, the discrete blanks 100 may be positioned between the punch 365 and die 370, as shown in FIG. 6A. The punch 365 and the die 370 are then moved toward one another such that curved portions 367 and 372 generally mate. The punch 365 can, for example, be moved toward the die 370 at a rate of about 25 ft/min (10 m/min) to about 500 ft/min (200 m/min) As the punch 365 and the die 370 are moved toward one another, protrusion 369 of the punch 365 contacts a region of the strip 350 offset from the sharpened edge 352. As the punch 365 and the die 370 mate with one another, the strip 350 is deformed into a bent position between the punch 365 and the die 370. Due to the configuration of the punch 365 and the die 367, the sharpened edge 352 can remain untouched throughout the bending process. This arrangement can help to prevent damage to the relatively delicate, the sharpened edge 352 of the discrete blanks 100. After the bending step, the bent blades 18 may be arranged in a stack for transport and/or for further processing, or assembled directly into cartridges.

Use of the disclosed method increases the choices of stainless steel materials (and other materials) and blade geometries for a bent blade. Furthermore, the disclosed method of bending may avoid the necessity to provide a local secondary heat treatment or scoring process to a portion of the blade body to enhance ductility and minimize macro-cracks in the bent portion of the blade. For example, U.S. Patent application publications 2007/0124939 and 2007/0234577 disclose methods of locally heat treating a portion of a hardened razor blade body to enhance ductility and thus facilitate formation of a bent portion. However, a localized heat treatment or scoring processes can be used with the present method if desired.

While certain embodiments have been described, other embodiments are possible. For example, the localized heat-treating processes described above can be used to heat treat blades other than the bent blades described above. For instance, a localized heat-treating process can be used to locally harden the edge of a blade. Moreover, the order of many of the process steps discussed above can be altered. The process steps can be ordered in any of various different combinations. As another example, while heat-treating device 310 has been described as being configured to treat an edge region of strip 350, heat treating device 310 can alternatively or additionally be arranged to treat additional regions of strip 350 (e.g., regions of strip 350 that are not intended to be sharpened by sharpening device 315). In some embodiments, for example the entire strip 350 is hardened by heat-treating device 310.

As a further example, while increasing the ductility of a region of strip 350 that is to be bent has been described above, additional or other regions of strip 350 (e.g., regions of strip 350 that are not intended to be bent by bending device 330) may be heat-treated to increase ductility. In certain embodiments, for example, substantially the entire strip 350 is heat-treated to increase its ductility. In some embodiments, as noted above, strip 350 is conveyed through a heat treating device to harden substantially the entire strip. After initially hardening substantially the entire strip an edge region of strip 350 is sharpened as described above. Then, strip 350 is subjected to heat treating to increase the ductility of substantially the entire strip, which can help to improve the bending of strip 350. Strip 350 can then be further processed as discussed above.

As another example, while the embodiments above describe heat-treating a discrete region of strip 350 to increase the ductility of that region, in certain embodiments, the cutting member forming process can be carried out without this heat-treating step. In such embodiments, strip 350 can be formed of a relatively ductile material. Strip 350 can be conveyed through heat-treating device 310 to locally harden an edge region of strip 350 so that the edge region can be sharpened. After being sharpened, strip 350 can be cut and bent without first heat-treating the bend region. The material from which strip 350 is formed, for example, can be sufficiently ductile so that the second heat-treating step is not required to prevent damage to the strip as a result of the bending process. After bending strip 350, the remainder of the process can be carried out in accordance with the description herein.

As an additional example, in some embodiments, a heating device is configured to apply heat to both longitudinal edges of strip 350. For example, one of the longitudinal edges can be heat-treated, as discussed above, in order to harden the region for sharpening, and the opposing longitudinal edge can be heat treated to reduce (e.g., to prevent) sweep within strip 350. For example, the opposing longitudinal edge can be heat-treated to substantially the same temperature as edge 352. In some embodiments, the regions that are heat-treated are symmetrical with respect to a center line of strip 350. Various types of hard carbon coatings such as amorphous diamond, diamond-like-carbon (DLC) and combinations with the above can be applied. An outer coating of a fluoropolymer material, preferably PTFE is applied.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor blade manufacturing process comprising the steps of:
cutting a strip of blade steel into discrete blanks each having an elongated edge and an elongated support portion extending between a pair of lateral end faces generally transverse to the elongated edge;
sharpening the elongated edge to form a cutting edge;
deforming the discrete blanks to form a bent portion; and
treating the pair of lateral end faces to remove cracks prior to deforming.

2. The method of claim 1 wherein pair of lateral end faces have an average roughness of about 0.45 um to about 1.0 um.

3. The method of claim 1 wherein pair of lateral end faces have an average roughness of about 0.45 um to about 1.0 um at the bent portion.

4. The method of claim 1 wherein treating the pair of lateral end faces includes grinding the pair of lateral end faces.

5. The method of claim 4 wherein the pair of lateral end faces are ground to an average roughness of about 0.45 um to about 1.0.

6. The method of claim 4 wherein the pair of lateral end faces are ground to an average roughness of about 0.45 um to about 0.60 um.

7. The method of claim 4 wherein the pair of lateral end faces are ground before sharpening to an average roughness of about 0.45 um to about 1.0 um at a distance of about 1.0 mm to about 2.5 mm from the elongated edge.

8. The method of claim 4 wherein the pair of lateral end faces are ground after sharpening to an average roughness of about 0.45 um to about 1.0 um at a distance of about 1.0 mm to about 2.5 mm from the cutting edge.

9. The method of claim 1 further comprising locally heating the discrete blanks prior to deforming.

10. The method of claim 1 further comprising hardening the discrete blanks after deforming.

11. The method of claim 1 wherein in deforming includes stamping the discrete blanks between a punch and a die.

12. A razor cartridge comprising:
a housing having a guard and a cap; and
a bent blade mounted to the housing between the guard and the cap, the bent blade comprising
(a) a cutting edge extending parallel to the cap and the guard,
(b) an elongated support portion,
(c) a bent portion between the cutting edge and the base portion, and
(d) a pair of lateral end faces generally transverse to the cutting edge,
wherein the lateral end faces have an average roughness of about 0.45 to about 1.0 um.

13. The razor cartridge of claim 12 wherein the bent portion has an outer surface free of macro cracks.

14. The razor cartridge of claim 12 wherein the lateral end faces have an average roughness of about 0.45 to about 1.0 um at the bent portion.

15. The razor cartridge of claim 12 wherein the pair of lateral end faces have an average roughness of about 0.45 um to about 0.60 um.

16. The razor cartridge of claim 12 wherein the pair of lateral end faces have an average roughness of about 0.45 um to about 1.0 um at a distance of about 1.0 mm to about 2.5 mm from the elongated edge.

17. The razor cartridge of claim 16 wherein the elongated support portion has a thickness of about 0.003″ to about 0.005″.

18. The razor cartridge of claim 17 wherein the bent portion has an inner radius of about 0.32 mm to about 0.76 mm.

19. The razor cartridge of claim 18 wherein the cutting edge of the blade of the bent blades have a hardness of at least 600 HV.

20. The razor cartridge of claim 19 wherein the first and second blades have a carbon content less than 0.60% by weight.
